(19) United States
(12) Patent Application Publication
(10) Pub. No.: US 2025/0241370 A1
(43) Pub. Date: Jul. 31, 2025

(54) ATOMIZER AND ELECTRONIC ATOMIZATION DEVICE

(71) Applicant: VERDEWELL INTERNATIONAL HOLDINGS LIMITED, George Town (KY)

(72) Inventors: Xiaojun ZHONG, Shenzhen (CN); Ju XIE, Shenzhen (CN); Zhixiao LUO, Shenzhen (CN); Qike LAN, Shenzhen (CN); Haiyan QU, Shenzhen (CN)

(21) Appl. No.: 19/032,977

(22) Filed: Jan. 21, 2025

(30) Foreign Application Priority Data
Jan. 25, 2024 (CN) 202410111289.8

(51) Int. Cl. A24F 40/46; A24F 40/10; A24F 40/42; A24F 40/48; H05B 3/42

(52) U.S. Cl. CPC A24F 40/46; A24F 40/10; A24F 40/42; A24F 40/48; H05B 3/42

(57) ABSTRACT

An atomizer includes: a liquid storage body having a liquid storage cavity and an air outlet channel formed therein; a base at least partially embedded in the liquid storage body; a heating component arranged in the base; a first electrode connector arranged in the liquid storage body and being in contact with and in communication with the heating component; and a second electrode connector insulatedly arranged to extend through the base and being in contact with and in communication with the heating component. A liquid flowing channel for bringing the heating component into communication with the liquid storage cavity and an air outlet hole for bringing the heating component into communication with the air outlet channel are formed on the first electrode connector.

### CROSS-REFERENCE TO PRIOR APPLICATION

Priority is claimed to Chinese Patent Application No. 202410111289.8, filed on Jan. 25, 2024, the entire disclosure of which is hereby incorporated by reference herein.

### FIELD

The present invention relates to the field of atomization technologies, and more specifically, to an atomizer and an electronic atomization device.

### BACKGROUND

An electronic atomization device generally includes an atomizer and a power supply device. The power supply device is configured to supply power to the atomizer. The atomizer is configured to store an aerosol-forming material and atomize the aerosol-forming material after being energized.

The atomizer generally includes a heating component configured to absorb the aerosol-forming material from a liquid storage cavity and atomize the aerosol-forming material after being energized. A conventional heating component is usually sintered in a ceramic core by using a winding heating wire. The heating wire needs to be trimmed, pressed, or soldered during assembly, which has a complicated process, low assembly efficiency, and a relatively large quantity of parts and components.

### SUMMARY

In an embodiment, the present invention provides an atomizer, comprising: a liquid storage body having a liquid storage cavity and an air outlet channel formed therein; a base at least partially embedded in the liquid storage body; a heating component arranged in the base; a first electrode connector arranged in the liquid storage body and being in contact with and in communication with the heating component; and a second electrode connector insulatedly arranged to extend through the base and being in contact with and in communication with the heating component, wherein a liquid flowing channel configured to bring the heating component into communication with the liquid storage cavity and an air outlet hole configured to bring the heating component into communication with the air outlet channel are formed on the first electrode connector.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of a three-dimensional structure of an electronic atomization device according to some implementations of the present invention.

FIG. 2 is a schematic diagram of a three-dimensional structure of an atomizer in FIG. 1.

FIG. 3 is a schematic diagram of a longitudinal cross-sectional structure of an atomizer shown in FIG. 2.

FIG. 4 is a schematic diagram of a three-dimensional structure of an atomization body in FIG. 3.

FIG. 5 is a schematic diagram of a longitudinal cross-sectional structure of an atomization body shown in FIG. 4.

FIG. 6 is a schematic diagram of a breakdown structure of the atomization body shown in FIG. 4.

FIG. 7 is a schematic diagram of a breakdown structure of the atomization body shown in FIG. 4 from another perspective.

FIG. 8 is a schematic diagram of an airflow path according to some modified embodiments of the present invention.

### DETAILED DESCRIPTION

In an embodiment, the present invention provides an improved atomizer and an electronic atomization device having the atomizer for the foregoing defects of the prior art.

In an embodiment, the present invention provides an atomizer, including:
a liquid storage body, having a liquid storage cavity and an air outlet channel formed therein;
a base, at least partially embedded in the liquid storage body;
a heating component, arranged in the base;
a first electrode connector, arranged in the liquid storage body and being in contact with and in communication with the heating component; and
a second electrode connector, insulatedly arranged to extend through the base and being in contact with and in communication with the heating component.

A liquid flowing channel that brings the heating component into communication with the liquid storage cavity and an air outlet hole that brings the heating component into communication with the air outlet channel are formed on the first electrode connector.

In some embodiments, the base is conductive, and the first electrode connector is fitted to an upper end of the base and is in contact with and in communication with the base.

In some embodiments, a first inclined guide surface is formed on an end of the first electrode connector connected to the heating component.

In some embodiments, a second inclined guide surface is formed on an end of the second electrode connector connected to the heating component.

In some embodiments, the liquid flowing channel is arranged on a side of the first electrode connector close to the heating component.

In some embodiments, the first electrode connector has a liquid flowing surface that defines at least part of a bottom boundary of the liquid storage cavity, and the liquid flowing surface has a slope toward the liquid flowing channel.

In some embodiments, the atomizer further includes a heating base arranged in the base. The heating component is mounted to the heating base, and an atomization cavity in communication with the air outlet channel is formed between the heating component and the heating base.

In some embodiments, a liquid collecting tank is formed in a lower portion of the atomization cavity, and the liquid collecting tank is in communication with the heating component.

In some embodiments, the heating component includes an atomization surface in air communication with the air outlet channel. The atomization surface is parallel to a longitudinal axis of the atomizer or an included angle is formed therebetween. The included angle is an acute angle.

The present invention further provides an electronic atomization device, including the atomizer as described above and a power supply device mated with the atomizer.

Implementation of the present invention has at least the following beneficial effects. In the present invention, the first electrode connector and the second electrode connector are in contact with and in communication with the heating component, which simplifies an assembly process. The first electrode connector is integrated with a liquid flowing channel and an air outlet hole, and has a modular design, which simplifies a quantity of parts and components.

To provide a clearer understanding of the technical features, objectives, and effects of the present invention, specific implementations of the present invention are described in detail with reference to the accompanying drawings. In the following description, numerous specific details are set forth to facilitate a thorough understanding of the present invention. However, the present invention may be implemented in many other manners different from those described herein. A person skilled in the art may make similar improvements without departing from the connotation of the present invention. Therefore, the present invention is not limited to the specific embodiments disclosed below.

In the description of the present invention, it should be understood that, orientation or position relationships indicated by terms such as “longitudinal”, “transverse”, “upper”, “lower”, “top”, “bottom”, “inner”, “outer”, are orientation or position relationships shown based on the accompanying drawings or orientation or position relationships that the product of the present invention is usually placed in use, and are merely used for describing the present invention and simplifying the description, rather than indicating or implying that the mentioned device or clement needs to have a particular orientation or needs to be constructed and operated in a particular orientation. Therefore, such terms should not be construed as a limitation on the present invention.

In addition, the terms “first” and “second” are merely used for the purpose of description, and cannot be construed as indicating or implying relative importance or implicitly indicating a quantity of the indicated technical features. Therefore, features defined with “first” and “second” may explicitly or implicitly include at least one of the features. In the description of the present invention, “a plurality of” means two, for example, two and three, unless otherwise explicitly and specifically defined.

In the present invention, unless otherwise explicitly specified and defined, terms such as “mounted”, “connected”, “fixed” should be understood in broad sense, for example, fixed connection, detachable connection, or integral connection; the connection may be a mechanical connection or an electrical connection; or the connection may be a direct connection, an indirect connection through an intermediary, or internal communication between two elements, or interaction between two elements, unless otherwise explicitly defined. A person of ordinary skill in the art may understand the specific meanings of the foregoing terms in the present invention according to specific situations.

In the present invention, unless otherwise explicitly specified and defined, the first feature being “on” or “above” or “below” or “under” the second feature may mean that the first feature and the second feature are in direct contact, or the first feature and the second feature are in indirect contact through an intermediary. In addition, the first feature being “on” or “above” the second feature may mean that the first feature is directly above or obliquely above the second feature, or may merely mean that a horizontal position of the first feature is higher than that of the second feature. The first feature being “below” or “under” the second feature may mean that the first feature is directly below or obliquely below the second feature, or may merely mean that the horizontal position of the first feature is lower than that of the second feature.

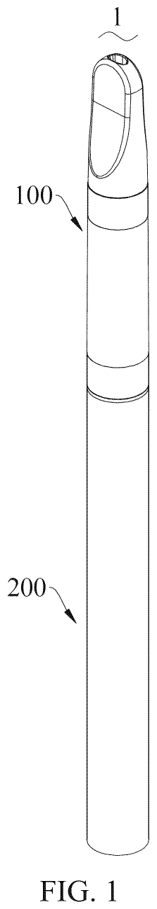

FIG. 1 shows an electronic atomization device 1 according to some embodiments of the present invention. The electronic atomization device 1 includes an atomizer 100 and a power supply device 200 mated with the atomizer 100. The power supply device 200 generally includes a battery configured to supply power to the atomizer 100 and a control circuit configured to control the atomizer 100 to generate heat.

The atomizer 100 is configured to accommodate an aerosol-forming material, and to heat and atomize the aerosol-forming material after being energized, to generate an aerosol. In some embodiments, the atomizer 100 and the power supply device 200 may be both substantially in the shape of a circular column, which may be mechanically and electrically connected together along an axial direction. Further, the atomizer 100 and the power supply device 200 may be connected together in a detachable manner such as a magnetic connection, a threaded connection, and a snap fit. It may be understood that in another embodiment, the atomizer 100 and the power supply device 200 may also be connected together in a non-detachable manner. In addition, a cross-sectional shape of the atomizer 100 and/or the power supply device 200 is not limited to a circle, and may also be another shape such as an ellipse, a racetrack, or a rectangle.

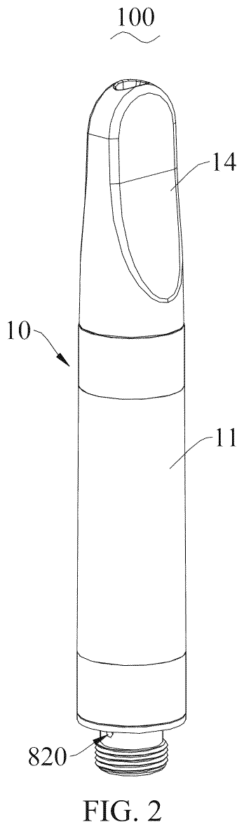

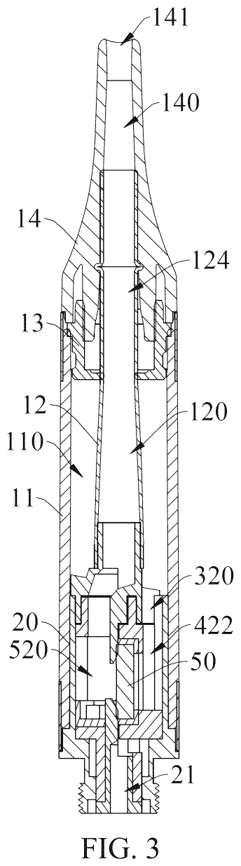

As shown in FIG. 2 and FIG. 3, the atomizer 100 may include a liquid storage body 10 and an atomization body 20 at least partially accommodated in the liquid storage body 10. A liquid storage cavity 110 configured to accommodate the aerosol-forming material and an air outlet channel 124 isolated from the liquid storage cavity 110 and configured to output the aerosol are formed in the liquid storage body 10. An end (shown as an upper end in the figure) of the liquid storage body 10 has an inhalation port 141 in communication with the air outlet channel 124. The atomization body 20 includes a heating component 50 in liquid communication with the liquid storage cavity 110 and in air communication with the air outlet channel 124. When a user smokes at the inhalation port 141, the heating component 50 atomizes the aerosol-forming material to form an acrosol. Then the aerosol reaches the inhalation port 141 through the air outlet channel 124 to be inhaled by the user.

In some embodiments, the liquid storage body 10 may include a liquid storage housing 11, an air guide tube 12 arranged in the liquid storage housing 11, and a suction nozzle 14 arranged at an upper end of the liquid storage housing 11. The liquid storage housing 11 may be, without limitation, in the shape of a circular tube open on both ends. The air guide tube 12 may be arranged in the liquid storage housing 11 along an axial direction and may be arranged coaxially with the liquid storage housing 11, but is not limited to being coaxially arranged. A guide channel 120 is formed in the air guide tube 12. A liquid storage cavity 110 in the shape of a circular ring is formed between an outer wall surface of the air guide tube 12 and an inner wall surface of the liquid storage housing 11.

The suction nozzle 14 is arranged at the upper end of the liquid storage housing 11, and covers an opening of the upper end of the liquid storage housing 11. An inhalation channel 140 is formed to extend through the suction nozzle 14 along the axial direction. The inhalation channel 140 is in communication with the guide channel 120 to form the air outlet channel 124. An upper end of the air guide tube 12 may be embedded in the inhalation channel 140, and is hermetically mated with a tube wall surface of the inhalation channel 140.

In some embodiments, the liquid storage body 10 may further include a seal member 13 arranged at the upper end of the liquid storage housing 11. The seal member 13 may be made of an elastic material such as silica gel. The seal member 13 is at least partially hermetically arranged between the inner wall surface of the liquid storage housing 11 and the outer wall surface of the air guide tube 12, and is configured to seal an upper end of the liquid storage cavity 110, to ensure air tightness between the liquid storage cavity 110 and the air outlet channel 124.

It may be understood that in another embodiment, the liquid storage body 10 is not limited to the foregoing specific structure. For example, the liquid storage housing 11, the suction nozzle 14, and the air guide tube 12 may also be integrally formed, thereby omitting a step of assembling the suction nozzle 14 and the seal member 13, and simplifying the assembly process. Certainly, in another embodiment, alternatively, the liquid storage housing 11 and the suction nozzle 14 may be integrally formed, and the air guide tube 12 is independently arranged. Alternatively, the liquid storage housing 11 and the air guide tube 12 are integrally formed, and the suction nozzle 14 is independently arranged.

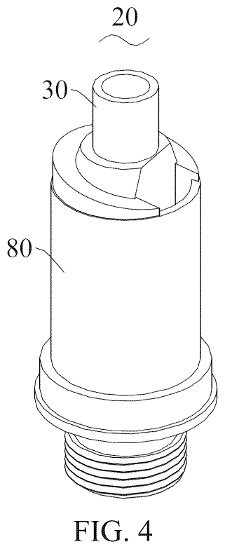

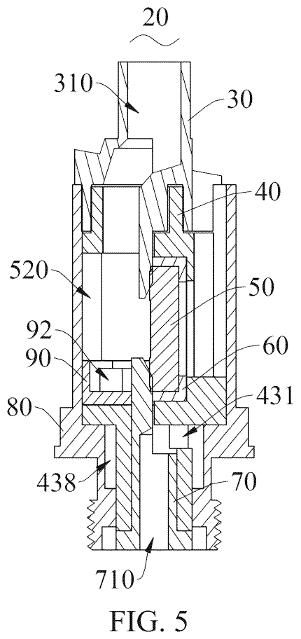

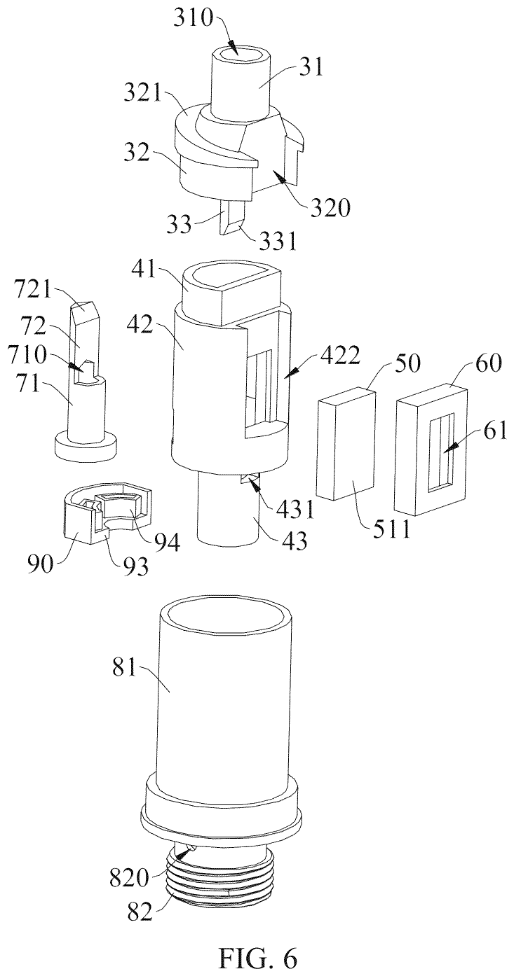

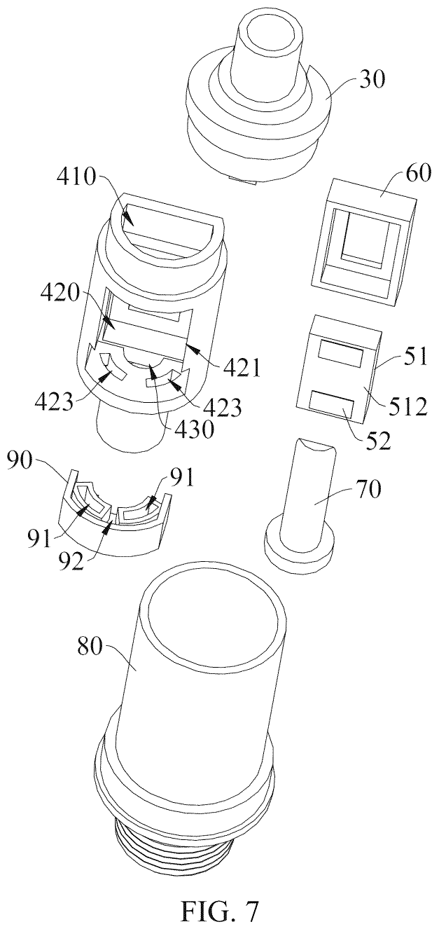

As shown in FIG. 3 to FIG. 7, the atomization body 20 is arranged at an end of the liquid storage housing 11 away from the inhalation port 141. The atomization body 20 may be substantially in a shape of a cylinder, and may include a base 80, a heating base 40 arranged in the base 80, a heating component 50 mounted to the heating base 40, and a first electrode connector 30 and a second electrode connector 70 electrically connected to the heating component 50.

The heating component 50 is mounted to the heating base 40, and an atomization cavity 520 is formed between the heating component and the heating base 40. The atomization cavity 520 is in communication with the air outlet channel 124. An air inlet channel 21 for external air to enter the atomization cavity 520 is further formed in the atomization body 20. When the user smokes at the inhalation port 141, the external air enters the atomization cavity 520 through the air inlet channel 21, and brings out the aerosol in the atomization cavity 520 through the air outlet channel 124.

The heating component 50 may include a liquid guide substrate 51 and a heating element 52 arranged on the liquid guide substrate 51.

Specifically, the heating element 52 may be attached to an outer surface of the liquid guide substrate 51, or may be partially or completely embedded in the heating element 52.

The liquid guide substrate 51 has a liquid absorbing surface 511 and an atomization surface 512. The liquid absorbing surface 511 is in liquid communication with the liquid storage cavity 110. The liquid guide substrate 51 absorbs the aerosol-forming material from the liquid storage cavity 110 through the liquid absorbing surface 511, and conducts the aerosol-forming material to the atomization surface 512. The atomization surface 512 defines a part of a boundary surface of the atomization cavity 520. The heating element 52 is arranged on the atomization surface 512, and is configured to heat and atomize the aerosol-forming material adsorbed by the liquid guide substrate 51 after being energized and generating heat.

In some embodiments, the liquid guide substrate 51 may be made of a porous material such as porous ceramics, natural cotton, or a high polymer material, so that a plurality of micropores are formed inside the liquid guide substrate 51 and have a certain porosity. Through a capillary action of the micropores, the liquid guide substrate 51 can absorb and buffer the aerosol-forming material.

In some embodiments, the liquid guide substrate 51 may be in a shape of a plate. The atomization surface 512 and the liquid absorbing surface 511 may be two surfaces of the liquid guide substrate 51 arranged opposite to each other in a thickness direction, so that the atomization surface 512 and the liquid absorbing surface 511 each have a relatively large area, which helps improve liquid absorbing efficiency and atomization efficiency.

A specific structure of the heating element 52 is not limited. For example, the structure may be a resistive heating film, a metal sheet, a metal mesh, or the like. In this embodiment, the heating element 52 is a heating film, which is beneficial to uniformly heat a surface of the heating component 50. The atomization surface 512 is a plane, so as to facilitate formation of a uniform heating film.

In some embodiments, the atomization surface 512 and the liquid absorbing surface 511 may be both arranged in a vertical direction, and the atomization surface 512 may be parallel to an axial direction of the atomizer 100, an axial direction of the liquid storage cavity 110, and an axial direction of the air outlet channel 124. The atomization surface 512 is parallel to the axial direction of the air outlet channel 124, so that an airflow can pass over the atomization surface 512 and take away the aerosol generated after atomization.

Correspondingly, the air inlet channel 21 includes an air inlet hole 91 in direct communication with the atomization cavity 520. An axial direction of the air inlet hole 91 may be parallel to the atomization surface 512, so that an air inlet direction of the external air when entering the atomization cavity 520 from the air inlet hole 91 is substantially parallel to the atomization surface 512, and the airflow can pass over the atomization surface 512 and take away the aerosol generated after atomization.

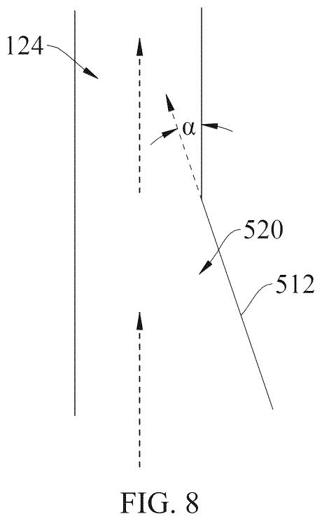

In some other embodiments, as shown in FIG. 8, the atomization surface 512 may also be obliquely arranged at an included angle a to the axial direction (that is, a vertical direction) of the atomizer 100, so that the atomization surface 512 is also arranged at the included angle a to the axial direction of the air outlet channel 124 and the axial direction of the air inlet hole 91. Preferably, the included angle a formed between the atomization surface 512 and the axial direction of the air outlet channel 124 and the axial direction of the air inlet hole 91 is an acute angle, so that a deflection angle of the airflow in a process of entering the atomization cavity 520 from the air inlet hole 91 and a deflection angle of the airflow in a process of entering the air outlet channel 124 from the atomization cavity 520 are both less than 90°, leading to smoother airflow and less smoke loss.

As shown in FIG. 3 to FIG. 7 again, the base 80 is arranged at a lower end of the liquid storage housing 11, and covers an opening of the lower end of the liquid storage housing 11. The base 80 may be in a shape of a hollow cylinder, which may include a body portion 81 and a threaded portion 82 extending downward from a lower end surface of the body portion 81. The body portion 81 is at least partially embedded in the liquid storage housing 11, and may be sealed and fixed to the liquid storage housing 11 in a manner such as interference fit. An inner diameter and an outer diameter of the body portion 81 are respectively greater than an inner diameter and an outer diameter of the threaded portion 82. An outer wall surface of the threaded portion 82 may be provided with external threads for threaded connection with a power supply device 200. At least one air inlet hole 820 for the external air to enter the atomization cavity 520 may be further formed on a side wall of the threaded portion 82. Preferably, at least two air inlet holes 820 may be evenly spaced along a circumferential direction on the side wall of the threaded portion 82.

In some embodiments, the base 80 may be made of a conductive material such as metal, which may be formed by using a process such as turning and has low manufacturing costs. An electrode of the heating component 50 may be electrically connected to the power supply device 200 through the base 80. Certainly, in another embodiment, the base 80 may also be made of an insulating material.

The first electrode connector 30 mates with and is mounted to an upper end of the base 80, and may be in contact with and in communication with the base 80. The heating component 50 is arranged in the base 80 and connected to and in communication with the first electrode connector 30, and then is electrically connected to the power supply device 200 through the base 80. A liquid flowing channel 320 that brings the heating component 50 into liquid communication with the liquid storage cavity 110 and an air outlet hole 310 that brings the atomization cavity 520 into communication with the air outlet channel 124 may be further formed on the first electrode connector 30.

The first electrode connector 30 has a liquid flowing surface 321 that defines at least part of a bottom boundary of the liquid storage cavity 110. In some embodiments, the liquid flowing surface 321 is an inclined plane having a certain inclination angle, which has a slope toward the liquid flowing channel 320, so that the aerosol-forming material in the liquid storage cavity 110 can flow smoothly along the liquid flowing surface 321 to the liquid flowing channel 320 under the action of gravity, liquid flowing is smoother, and the aerosol-forming material can be fully utilized. Certainly, in another embodiment, the liquid flowing surface 321 may also be a curved structure such as an arc surface.

The first electrode connector 30 is made of metal, which may be formed by using a process such as forging or computer numerical control (CNC). In some embodiments, the first electrode connector 30 may include a body portion 32, an air channel portion 31 extending upward from an upper end surface of the body portion 32, and a communication portion 33 extending downward from the body portion 32. The air channel portion 31 may be in the shape of a circular tube, and an inner wall surface thereof defines the air outlet hole 310. The air channel portion 31 may be sleeved and mated with a lower end of the air guide tube 12. Specifically, the air channel portion 31 may be embedded in the lower end of the air guide tube 12, or may be sleeved outside the lower end of the air guide tube 12.

The body portion 32 is at least partially embedded in the base 80, and may be hermetically attached to an inner wall surface of the base 80 by interference fit or the like, which facilitates sealing and fixing between the first electrode connector 30 and the base 80, and can improve reliability of electrical connection between the first electrode connector 30 and the base 80.

The upper end surface of the body portion 32 forms the liquid flowing surface 321. The liquid flowing channel 320 may be arranged on a side of the body portion 32, and may extend downward from the liquid flowing surface 321. After the body portion 32 is embedded in the base 80, an outer opening of the liquid flowing channel 320 is covered by the inner wall surface of the base 80, and an upper opening of the liquid flowing channel 320 is in communication with the liquid storage cavity 110. Preferably, the liquid flowing channel 320 is arranged on a side of the first electrode connector 30 close to the heating component 50. A temperature of the heating component 50 preheats the acrosol-forming material, so that the liquid flowing is smoother. A size of the liquid flowing channel 320 may be adjusted based on a size of the heating component 50 or a liquid supply requirement.

A lower end of the communication portion 33 extends into the atomization cavity 520, and may abut against and be in communication with an upper end of the heating element 52. The communication portion 33 may be in a shape of a strip or a sheet, and a side surface of the communication portion in contact with the heating element 52 is a plane, which helps improve reliability of being in contact with and in communication with the heating element 52. In some embodiments, an end of the communication portion 33 connected to the heating element 52 may be in a shape of a wedge. An inclined guide surface 331 is formed on a side of the wedge-shaped end portion abutting against the heating element 52. The inclined guide surface 331 may be an inclined plane or an arc surface, to facilitate mounting.

The second electrode connector 70 is made of metal, which may be formed by using a process such as forging or CNC. The second electrode connector 70 is arranged to extend through the threaded portion 82 of the base 80 along the axial direction, and is insulated and isolated from the base 80. An upper end of the second electrode connector 70 extends into the atomization cavity 520, and may abut against and be in communication with a lower end of the heating element 52.

In some embodiments, the second electrode connector 70 may be arranged to extend through the heating base 40 along the axial direction, and may be sealed and fixed to the heating base 40 in a manner such as interference fit. The heating base 40 may be made of an insulating material such as plastic. The second electrode connector 70 is separated from the base 80 by the heating base 40, to ensure electrical insulation between the second electrode connector 70 and the base 80.

In some embodiments, the second electrode connector 70 may include a cylindrical portion 71 and a connecting portion 72 successively arranged from bottom to top along the axial direction. The cylindrical portion 71 may be in a shape of a cylinder. The cylindrical portion 71 is arranged to extend through the heating base 40 along the axial direction, and may be hermetically mated with an inner wall surface of the heating base 40 to prevent liquid leakage. The connecting portion 72 may be substantially in a shape of a C-shaped column, and a side of the connecting portion in contact with the heating element 52 is a plane, which helps improve reliability of electrical connection between the connecting portion 72 and the heating element 52. Further, an upper end of the connecting portion 72 may be in a shape of a wedge. An inclined guide surface 721 is formed on a side of the wedge-shaped end portion in contact with the heating element 52. The inclined guide surface 721 may be an inclined plane or an arc surface, to facilitate mounting.

In some embodiments, a vent hole 710 may be further formed on the second electrode connector 70. The vent hole 710 may extend upward from a bottom surface of the cylindrical portion 71, and may be coaxially arranged with the cylindrical portion 71. The external air may enter the atomization cavity 520 through the vent hole 710.

The heating base 40 is arranged in the base 80, and the heating component 50 is at least partially embedded in the heating base 40. Specifically, a mounting cavity 420 is formed on an open circumferential side of the heating base 40. The heating component 50 may be press-fitted into the mounting cavity 420.

In some embodiments, the heating base 40 may include a base body 42, an upper tube portion 41 extending upward from an upper end surface of the base body 42, and a lower tube portion 43 extending downward from a lower end surface of the base body 42. The upper tube portion 41 may be sleeved and mated with the first electrode connector 30, and an inner wall surface of the upper tube portion 41 defines an air outlet hole 410 in communication with the air outlet hole 310. Specifically, in this embodiment, the upper tube portion 41 may be embedded in the body portion 32 of the first electrode connector 30 for fixation.

The lower tube portion 43 may be in the shape of a circular tube and may be arranged in the threaded portion 82 along the axial direction. An inner wall surface of the lower tube portion 43 defines an electrode hole 430 for insertion of the second electrode connector 70. An outer wall surface of the cylindrical portion 71 of the second electrode connector 70 may be hermetically mated with a hole wall surface of the electrode hole 430 in a manner such as interference fit, so as to seal the electrode hole 430 and prevent the aerosol-forming material from leaking from the electrode hole 430.

In some embodiments, an annular airflow channel 438 may be further formed between an outer wall surface of the lower tube portion 43 and an inner wall surface of the threaded portion 82. An air inlet port 431 may be provided to extend through a side wall of the lower tube portion 43. The air inlet port 431 may bring the vent hole 710 into communication with the airflow channel 438. An air inlet hole 423 bringing the air airflow channel 438 into communication with the atomization cavity 520 may be further provided to extend through a bottom wall of the base body 42. A quantity and shapes of the air inlet holes 423 are not limited. Specifically, one or more air inlet holes 423 may be provided. The air inlet holes 423 may be in various regular or irregular shapes such as a circle, a square, and an ellipse. In this embodiment, two air inlet holes 423 are provided. The two air inlet holes 423 may be in a shape of a circular arc and may be spaced apart on a same circumference.

When the user smokes at the inhalation port 141, the external air enters the atomization cavity 520 successively through the vent hole 710, the air inlet port 431, the airflow channel 438, and the air inlet hole 423. In addition, the air inlet hole 820 serves as a supplement for air, and the external air enters the atomization cavity 520 successively through the air inlet hole 820, the airflow channel 438, and the air inlet hole 423, and brings out the acrosol in the atomization cavity 520 through the air outlet channel 124.

The airflow channel 438 is in a shape of a ring, so that an assembly direction does not need to be considered during assembly of the heating base 40 and the base 80, and alignment is not required during the assembly, which is more convenient to operate.

The base body 42 may be substantially in the shape of a circular tube, and a mounting cavity 420 for mounting the heating component 50 is formed thereon. An opening 421 is formed on a circumferential side of the mounting cavity 420 on the base body 42. The heating component 50 may be press-fitted into the mounting cavity 420 through the opening 421. After the heating base 40 is mounted to the base 80, the opening 421 of the mounting cavity 420 is covered and sealed by the inner wall surface of the base 80, thereby forming the atomization cavity 520.

In some embodiments, the atomization body 20 may further include a seal gasket 60 sleeved on the heating component 50. The heating component 50 may abut against the base body 42 through the seal gasket 60. The seal gasket 60 may be made of an elastic material such as silica gel, which not only can prevent liquid leakage, but also can protect the heating component 50 from being crushed during mounting. The seal gasket 60 may be substantially in a shape of a rectangular ring and wrapped around a circumference of the heating component 50, to seal the circumference of the heating component 50. A liquid inlet port 61 that brings the liquid storage cavity 110 into communication with the liquid absorbing surface 511 is provided to extend through the seal gasket 60. The liquid inlet port 61 may expose most of a surface of the liquid absorbing surface 511, which helps improve liquid absorbing efficiency of the heating component 50.

A liquid inlet channel 422 is further formed on the base body 42 corresponding to the liquid flowing channel 320. The aerosol-forming material in the liquid storage cavity 110 can be adsorbed by the liquid absorbing surface 511 of the heating component 50 successively through the liquid flowing channel 320, the liquid inlet channel 422, and the liquid inlet port 61, and then atomized. In some embodiments, the liquid inlet channel 422 may be arranged on a side close to the heating component 50. The temperature of the heating component 50 preheats the aerosol-forming material, so that the liquid flowing is smoother. In this embodiment, the liquid inlet channel 422 and the opening 421 are respectively located on two opposite sides of the base body 42. After the heating base 40 is mounted to the base 80, inner wall surfaces on the two sides of the base 80 can respectively cover side openings of the liquid inlet channel 422 and the opening 421 of the mounting cavity 420.

In some embodiments, a liquid collecting tank 92 may be further formed on a lower portion of the atomization cavity 520, which is configured to store a condensate and the acrosol-forming material permeating the heating component 50, to prevent the liquid from leaking to outside and affecting use of a consumer. During operation or placement of the atomizer 100, the aerosol-forming material may permeate and flow into the atomization cavity 520 through the heating component 50. Through the design of the liquid collecting tank 92, the leaked aerosol-forming materials can be well stored. The liquid collecting tank 92 is arranged on the lower portion of the atomization cavity 520 and on a side in which the heating element 52 is located. Therefore, during operation of the heating component 50, the heating element 52 can recycle and atomize the acrosol-forming material in the liquid collecting tank 92, to avoid a waste.

Further, a certain height difference is formed between the liquid collecting tank 92 and the air inlet hole 91 at an end of the air inlet channel 21. Specifically, an upper end surface of the air inlet hole 91 is at least higher than a bottom wall surface of the liquid collecting tank 92, to prevent liquid in the liquid collecting tank 92 from flowing out of the air inlet hole 91.

In some embodiments, the atomization body 20 may further include a liquid collecting member 90. The liquid collecting member 90 is arranged on the lower portion of the atomization cavity 520, which may be embedded in the mounting cavity 420 through the opening 421 of the heating base 40. The liquid collecting tank 92 and the air inlet hole 91 may be both formed on the liquid collecting member 90. Certainly, in another embodiment, the liquid collecting member 90 may also be integrally formed with the heating base 40.

In some embodiments, the liquid collecting member 90 may include a bottom wall 93 and an encircling rib 94 protruding from the bottom wall 93. The bottom wall 93 may abut against a bottom wall surface of the mounting cavity 420, and an upper end surface of the bottom wall 93 defines the bottom wall surface of the liquid collecting tank 92.

The encircling rib 94 may be in a shape of a ring, and an inner wall surface thereof defines the air inlet hole 91. In this embodiment, two air inlet holes 91 are provided. The air inlet holes 91 are respectively in communication with the two air inlet holes 423 in one-to-one correspondence. The air inlet hole 91 and the air inlet hole 423 have a same cross-sectional shape and a same cross-sectional area. Correspondingly, two encircling ribs 94 are also arranged. Certainly, in another embodiment, shapes and a quantity of the air inlet holes 91 and the encircling ribs 94 may not be limited. In addition, the air inlet hole 91 may also have a different cross-sectional shape and/or cross-sectional area from the air inlet hole 423.

The atomizer 100 may be assembled in a modular manner, and assembly steps thereof may be as follows. (1) First, the seal gasket 60 is sleeved on the heating component 50, and then the heating component 50 and the seal gasket 60 are mounted to the heating base 40 by interference fit. (2) The liquid collecting member 90 is press-fitted onto the heating base 40. (3) The heating base 40 is mounted to the base 80. (4) The first electrode connector 30 and the second electrode connector 70 are assembled to form the atomization body 20. (5) Finally, the atomization body 20 is pressed into the liquid storage housing 11, and the seal member 13 and the suction nozzle 14 are mounted after liquid injection.

It may be understood that the foregoing technical features may be used in any combination without limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An atomizer, comprising:
a liquid storage body having a liquid storage cavity and an air outlet channel formed therein;
a base at least partially embedded in the liquid storage body;
a heating component arranged in the base;
a first electrode connector arranged in the liquid storage body and being in contact with and in communication with the heating component; and
a second electrode connector insulatedly arranged to extend through the base and being in contact with and in communication with the heating component,
wherein a liquid flowing channel configured to bring the heating component into communication with the liquid storage cavity and an air outlet hole configured to bring the heating component into communication with the air outlet channel are formed on the first electrode connector.

2. The atomizer of claim 1, wherein the base is conductive, and
wherein the first electrode connector is fitted to an upper end of the base and is in contact with and in communication with the base.

3. The atomizer of claim 1, wherein a first inclined guide surface is formed on an end of the first electrode connector connected to the heating component.

4. The atomizer of claim 3, wherein a second inclined guide surface is formed on an end of the second electrode connector connected to the heating component.

5. The atomizer of claim 1, wherein the liquid flowing channel is arranged on a side of the first electrode connector close to the heating component.

6. The atomizer of claim 1, wherein the first electrode connector has a liquid flowing surface that defines at least part of a bottom boundary of the liquid storage cavity, and
wherein the liquid flowing surface has a slope toward the liquid flowing channel.

7. The atomizer of claim 1, further comprising:
a heating base arranged in the base,
wherein the heating component is mounted to the heating base, and
wherein an atomization cavity in communication with the air outlet channel is formed between the heating component and the heating base.

8. The atomizer of claim 7, wherein a liquid collecting tank is formed in a lower portion of the atomization cavity, and
wherein the liquid collecting tank is in communication with the heating component.

9. The atomizer of claim 1, wherein the heating component comprises an atomization surface in air communication with the air outlet channel, and
wherein the atomization surface is parallel to a longitudinal axis of the atomizer or an included angle is formed therebetween, and the included angle is an acute angle.

10. An electronic atomization device, comprising:
the atomizer of claim 1; and
a power supply device mated with the atomizer.
